(19) United States
(12) Patent Application Publication
(10) Pub. No.: US 2004/0208795 A1
(43) Pub. Date: Oct. 21, 2004

(54) Automatic liquid handling system

(76) Inventors: Hiroatsu Toi, Hitachinaka-shi (JP); Kenji Yamada, Hitachinaka-shi (JP); Hidetaka Osawa, Hitachinaka-shi (JP); Tadashi Ohkawara, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/825,097

(22) Filed: Apr. 16, 2004

(30) Foreign Application Priority Data
Apr. 16, 2003 (JP) P2003-112217

(51) Int. Cl. B01L 3/02

(52) U.S. Cl. 422/100

(57) ABSTRACT

In order to eliminate any mistakes regarding attachment or removal of dispensing tips to and from a dispensing head provided in an automatic liquid handling system used for dispensing an object to be examined, reagent, enzymes or the like into wells of a microplate, a dispensing tip sensor is provided to sense if the dispensing tips are attached to the head. The sensor includes a light emitting unit and a light receiving unit which are disposed above and diagonally opposite positions of a disposal container in which used dispensing tips are disposed of. The dispensing head with some dispensing tips attached thereto moves to traverse the light path of the sensor, thereby enabling sensing of the dispensing tips attached to the head.

### BACKGROUND OF THE INVENTION

1. Field of the Invention

The present invention relates to an automatic liquid handling system used, for example, for dispensing an object to be examined, reagent or enzymes that are used in drug metabolic experiments.

2. Description of the Related Art

Dispensing an object to be examined, reagent or the like are frequently carried out not only in drug metabolic experiments but also in other experiments. Each experiment is involved with a large amount of work and any mistakes caused by human error have to be eliminated. To this end, human operations tend to be replaced by automatic mechanical operations. In the automatic mechanical operations, it is essential to eliminate any mistakes of attachment of the dispensing tips to and removal of the dispensing tips from a dispensing head. Even if such mistakes eventually occur, it is necessary that the mistakes be accurately detected.

Japanese Patent Application Publication No. 2001-59848 discloses an automatic liquid handing system that includes a three-dimensionally movable robot having a tip end on which a single dispensing tip is detachably mounted. Sensors are disposed in the mounting and depositing positions of the dispensing tips to sense the presence or absence of the dispensing tips.

Japanese Patent Application Publication No. 11-295323 discloses another type of automatic liquid handling system that is capable of detecting a failure in mounting on a head dispensing tips arranged in a dispensing tip container. A sensor is disposed in the dispensing tip container to detect that a dispensing tip stays in the container after the dispensing tip mounting operation is completed.

The automatic liquid handing system disclosed in Japanese Patent Application Publication No. 2001-59848 is disadvantageous in that a great deal of experiments cannot be conducted with a single dispensing tip. Particularly, the system disclosed therein is not applicable to drug metabolic experiments in which a drug is simultaneously dispensed to a plurality of wells arranged on a microplate. To perform the drug metabolic experiments or the like, the system is required to have a capability of simultaneously mounting and dismounting a plurality of dispensing tips on and from a head.

Further, when performing this type of experiment using such a handling system, the operator has to determine arrangement positions of the dispensing tips in a container and actually arrange the dispensing tips in the relevant positions in the container. It has been proposed an automatic liquid handing system that facilitates the dispensing tip arrangement operations by the operator. In this system, the positions in the dispensing tip container where the dispensing tips are arranged are calculated, and the operator arranges the dispensing tip in the container while referring to the results of calculation.

The automatic liquid handing system disclosed in Japanese Patent Application No. 11-295323 is capable of mounting and dismounting a plurality of dispensing tips on and from a head and determines that mounting of the dispensing tips on the head is properly performed if no dispensing tips remains in the container. Therefore, even if the dispensing tips were not arranged in the relevant positions in the container, judgement is made so that mounting of the dispensing tips is properly performed if no dispensing tips remain in the container. As a result, dispensing operations may be performed for unintended wells or dispensing operations may not be performed for intended wells. Further, whether all the dispensing tips have been successfully removed from the head is not detected after dismounting operations of the tips. Therefore, when one or more dispensing tips accidentally stays in the head after dismounting operations of the tips, the subsequent dispensing tip mounting operation is performed with respect to the head in which some dispensing tips remain dismounted, resulting in destroying the tips or damaging the system.

### SUMMARY OF THE INVENTION

The present invention has been made to solve the aforementioned drawbacks accompanying the conventional liquid handing system. To this end, the present invention provides an automatic liquid handling system that includes a dispensing tip container, a dispensing head, a head moving mechanism, a sensor, and a control device. The dispensing tip container has a plurality of holding portions for holding dispensing tips. The dispensing head has attachment portions to which at least one dispensing tip is attached. When one or more dispensing tips are attached to the attachment portions, the dispensing head is capable of performing sucking and expelling operations for sucking liquid in or expelling the liquid out from the one or more dispensing tips. The moving mechanism moves the dispensing head. The sensor senses if one or more dispensing tips are attached to the attachment portions of the dispensing head when the head moves relative to the sensor. The sensor has a sensing region that extends in a direction slanted with respect to a direction in which the head moves, and generates an output indicative of a status of the dispensing tips attached to the attachment portions of the dispensing head. The control device controls the sucking and expelling operations performed by the dispensing head and controls the moving mechanism to control movements of the dispensing head.

Preferably, the sensors are of an optical type having, for example, a light emitting unit and a light receiving unit disposed apart a predetermined distance from the light emitting unit. A light path, that is, the sensing region, is formed between the light emitting unit and the light receiving unit. The moving mechanism moves the dispensing head to traverse the light path or the sensing region to sense the dispensing tips attached to the dispensing head.

There is provided a memory storing information about a number of dispensing tips to be attached to the attachment portions of the dispensing head with position data indicating the holding portions to which the dispensing tips are to be attached. The control device compares the output of the sensor with the information stored in the memory. With this comparison, redundant or missing dispensing tips can be sensed. Specifically, when the control device generates a comparison result indicating that the output of the sensor and the information stored in the memory are not in coincidence with each other, the control device determines that an error has occurred and so controls the moving mechanism to stop movement of the dispensing head.

### BRIEF DESCRIPTION OF THE DRAWINGS

In the drawings:

FIG. 1 is a perspective view of an automatic liquid handling system according to an embodiment of the present invention;

FIG. 2 is an explanatory diagram illustrating an arrangement of dispensing tip container, reagent container, microplate, and disposal container; an arrangement of dispensing tip detectors; and a reference position of a dispensing head when the dispensing tips are detected;

FIG. 3 is a perspective view of the dispensing tip detectors;

FIG. 4 shows an example of the screen for creating the process and timers according to an embodiment of the present invention;

FIG. 5 is a flowchart showing a self-determination function of an embodiment of the present invention;

FIG. 6 is a graphical representation showing movement of a robot;

FIG. 7 is a flowchart showing the sequence of operations from the input of the process to execution of the process;

FIG. 8 is a flowchart showing the sequence of operations to be executed for determining the dispensing tip arrangement according to an embodiment of the present invention;

FIG. 9 is an, explanatory diagram showing an arrangement of dispensing tips and reagent and an indication of the quantity of reagent according to an embodiment of the present invention; and

FIG. 10 shows an example of a process table for a metabolic experiment.

### DETAILED DESCRIPTION OF THE PREFERRED EMBODIMENTS

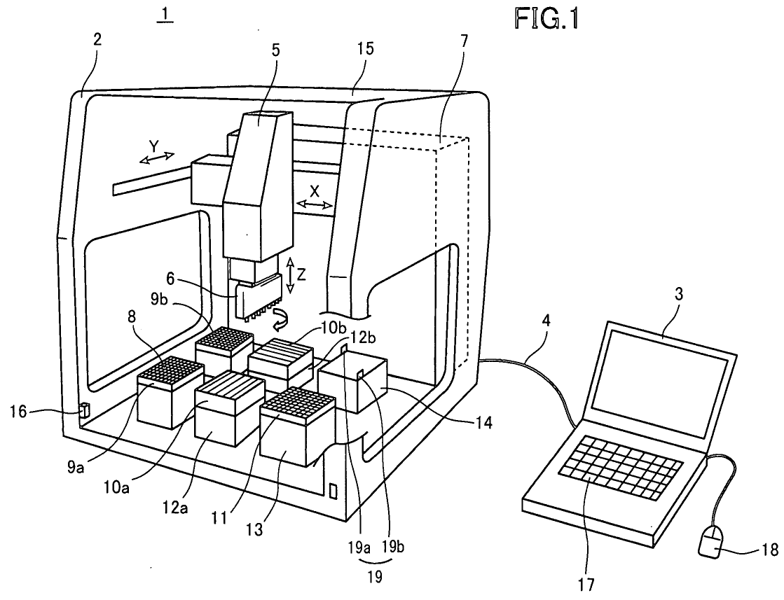

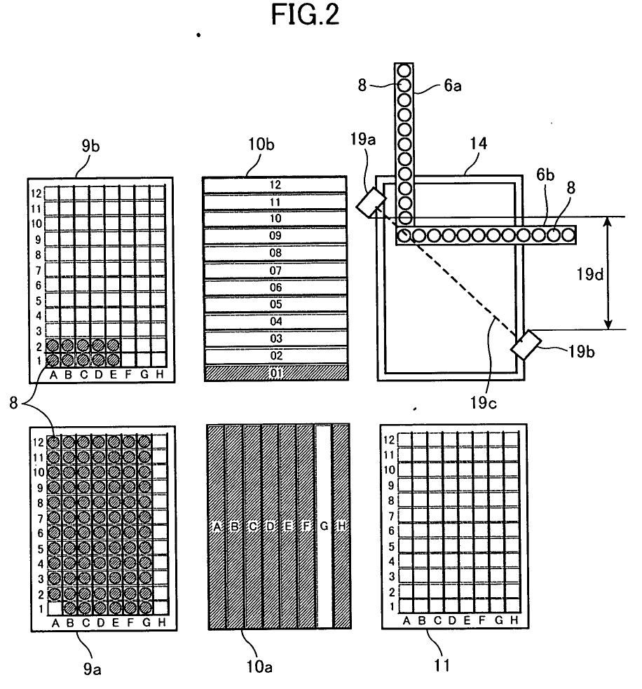

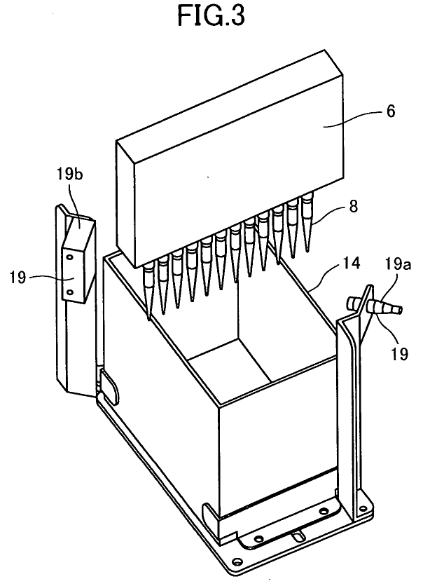

A preferred embodiment of the present invention will be described with reference to the drawings. FIG. 1 shows an automatic liquid handling system 1 according to a preferred embodiment of the present invention. FIG. 2 shows an arrangement of each of the containers accommodated in a main body 2 of the automatic liquid handling system 1 as viewed from above. The automatic liquid handling system 1 includes the main body 2 and a control device 3 connected together with a communication cable 4 such as a LAN (Local Area Network) cable. A general-purpose personal computer is used as the control device 3. The main body 2 of the automatic liquid handling system 1 includes a robot 5 capable of moving and stopping in 3D space, a dispensing head 6 provided at a tip end of the robot 5, and a driving circuit 7 for driving the main body 2 based upon conditions input into the control device 3.

The robot 5 has three orthogonal axes, X, Y, and Z, and is capable of being moved by stepper motors (not shown) to a predetermined position. Servo-motors can be used instead of the stepper motors. A plurality of dispensing tips 8 aligned at an equi-pitch can be removably attached to the dispensing head 6. The dispensing tips attached to the dispensing head 6 can suck or expel liquid. Specifically, the dispensing head 6 can hold, for example, twelve syringes (not shown in the drawings) which are driven by one stepper motor. The spacing between syringes is 9 mm pitch, the same as the spacing between wells of a microplate 11. When one or more dispensing tips 8 are attached to the dispensing head 6, liquid can be sucked in or expelled out by driving the syringe.

Arranged beneath the dispensing head 6 of the robot 5 are a dispensing tip container 9, reagent containers 10, the microplate 11, and a disposal container 14. The dispensing tip container 9 has dispensing tip holding portions arranged at a pitch same as the well pitch of the microplate 11, that is, 9 mm pitch. The reagent container 10 holds reagent that is used in an experiment. The microplate 11 holds a specimen subject to the experiment. The disposal container 14 holds used dispensing tips 8. A plurality of wells is formed in the microplate 11 in an n-by-m matrix arrangement. For example, an 8-by-12 arrangement would have 96 wells. Also, the dispensing head 6 is capable of swiveling through 90 degrees, so that it is capable of dispensing to the microplate 11 in the two orthogonal directions.

In positions above the disposal container 14, a dispensing tip sensor 19 is provided for sensing the dispensing tips 8 mounted on the dispensing head 6. The dispensing tip sensor 19 used in this embodiment is a photoelectric sensor that includes a light emitting unit 19a and a light receiving unit 19b and senses a dispensing tip 8 when traversing the light path extending from the light emitting unit 19a to the light receiving unit 19b. The dispensing head 6 is capable of mounting an array of the dispensing tips 8 aligned in the direction of X axis or Y axis in the dispensing tip container 9. In the illustrated embodiment, eight dispensing tips 8 are arranged in the direction of X axis, and twelve dispensing tips 8 in the direction of Y axis. The dispensing head 6 is capable of mounting the dispensing tips 8 arranged in either of the two directions at a time. Irrespective of which array of the dispensing tips 8 the dispensing head 6 mounts, the light emitting unit 19a and the light receiving unit 19b are arranged to allow each of the dispensing tips 8 to successively traverse the light path between the light emitting unit 19a and the light receiving unit 19b as the dispensing head 6 moves over the X-Y plane.

More specifically, as shown in FIG. 2, the light emitting unit 19a and the light receiving unit 19b are arranged above and in the vicinity of two diagonally opposite corners of the disposal container 14 so that the path of light emitted from the light emitting unit 19a and received at the light receiving element 19b forms about 45 degrees with respect to the X axis or Y axis. With the dispensing detector 19 thus arranged, each of the dispensing tips 8 mounted on the head 6 can be sensed regardless of whether the dispensing head 6 is oriented in the direction of X axis or Y axis. A distance (19d) between the light emitting unit 19a and the light receiving unit 19b may be as short as a distance through which a single dispensing tip 8 can pass.

The light emitting unit 19a and the light receiving unit 19b may be disposed above and in opposite sides of the disposal container 14 so that the light path from the light emitting unit 19a to the light receiving unit 19b extends in the direction of X axis or Y axis. In this case, the orientation in which the head 6 directs is limited to one of the X- and Y-axis directions depending upon which direction the light path extends to.

The output from the dispensing tip sensor 19 is applied to the control device 3 through the driver circuit 7 of the main body 2 and the communication cable 4. It should be noted that the dispensing tip sensor 19 is not limited to the one described above but any other type of sensors is applicable, such as sensors using laser beam or ultrasonic wave.

Referring again to FIG. 1, a cover 15 is provided to the ceiling part and the side faces of the main body 2 of the automatic liquid handling system 1. Also, a door (not shown in the drawings) is provided to the front of the main body 2. The door is opened when preparing reagent or test specimens, and during execution of the experiment the door is closed and the automatic liquid handling system 1 is operated. For the sake of safety of the operators, a reed switch 16 is provided to detect whether the door is open or closed. When the door is open, the contacts of the reed switch 16 are rendered open, causing the electrical power lines to the motors to interrupt and thus the robot 5 to stop.

In the arrangement shown in FIG. 2, dispensing tip containers 9a and 9b are disposed at the left side for holding the dispensing tips 8 arranged in an array. Reagent containers 10a and 10b are disposed at the center, and the microplate 11 and the disposal container 14 are disposed at the right side. The area for holding reagent in the reagent container 10a is divided into columns “A” to “H”. Also the area for holding reagent in the reagent container 10b is divided into rows “1” to “12”. Different reagents can be dispensed into each row or column of reagent containers 10a and 10b. When the dispensing head 6 is in such an orientation that the lengthwise direction of the head 6 is in coincidence with the direction in which the column extends, the dispensing tip container 9a and reagent container 10a are used. When the dispensing head 6 is swiveled 90 degrees and the lengthwise direction thereof is in coincidence with the direction in which the row extends, then the dispensing tip container 9b and reagent container 10b are used. The disposal container 14 is sufficiently large for disposing of the used dispensing tips regardless of whether the dispensing head 6 is oriented in the direction of column or row.

The arrangement shown in FIG. 2 is only an example, and the arrangement of containers can be freely changed to meet the requirements of the experiment. However, it is necessary to input and save information regarding the arrangement of containers to a memory (not shown) of the control device 3 in advance.

When carrying out reagent reaction experiments, the reagent is normally refrigerated. In this embodiment, cooling devices 12a and 12b are disposed below the reagent containers 10a and 10b respectively, as shown in FIG. 1, to maintain the reagent at, for example, 4° C. Also, in order to shake the microplate 11 after reagent is dispensed into the microplate 11, the microplate 11 is placed on a shaker 13 and is shook thereby while maintaining a fixed temperature. This operation is referred to as incubating.

The control device 3 controls the robot 5 to bring the dispensing head 6 to the desired position, and controls the dispensing head 6 to execute liquid sucking in or expelling operations. Also, the control device 3 controls the robot 6 so that the dispensing tips 8 mounted on the dispensing head 6 successively traverse the light path of the dispensing tip sensor 19. The control device 3 is applied with the output from the dispensing tip sensor 19 and determines whether the dispensing tip 8 is sensed.

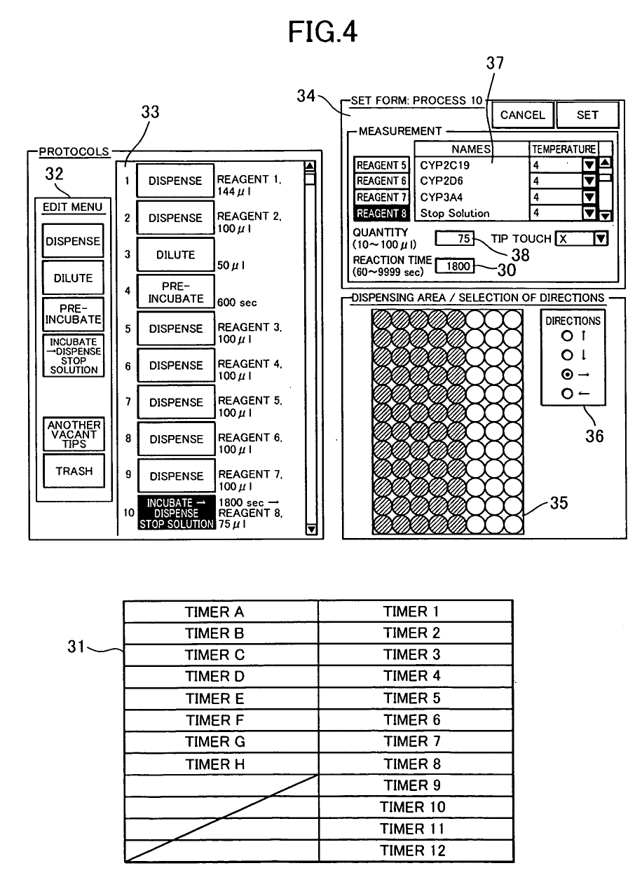

Also, the process (protocol) of a reagent reaction experiment, such as that shown in FIG. 4, can be input to the control device 3. For inputting the process to the control device 3, a keyboard 17 or a mouse 18 is used.

FIG. 4 shows an example of an input screen for inputting the experimental process. When composing the experimental process, each step to be executed is selected from an edit menu 32 at the left side of the input screen, and the selected step is entered into a process column 33. If “DISPENSE” is selected from the edit menu 32 and entered into the process column 33, then an information input screen 34 appears at the right side of the process column 33 for inputting all the information needed for the dispense operation. With the information input screen 34, various kinds of information can be input including reagent 37 to be selected, the dispense quantity 38, the range of dispense destination wells 35, and dispense direction 36. For example, the symbol → means to carry out dispense operations in the direction from column “A” toward column “H” in the microplate 11. Also, the symbol ↑ means to carry out dispense operations in the direction from row “1” toward row “12” of the microplate 11.

The information input screen 34 illustrated in FIG. 4 is for a reaction stop solution dispensing step to be carried out following an incubate step. The information input screen 34 includes a time setting portion 30 for setting a period of time from dispensing of the reagent to subsequent dispensing of the reaction stop solution (hereinafter referred to as “predetermined period of time). The range of wells 35 in the microplate 11 into which the stop solution is to be dispensed can be specified on an individual basis or on a row or a column basis. Furthermore, the control device 3 includes timers 31 for measuring a period of time from immediately after reagent is dispensed into each row or each column of the microplate 11. When the control device 3 is executing a process, the control device 3 compares the period of time measured by the timer 31 with the predetermined period of time set in the time setting portion 30. Dispensing the reaction stop solution will not be executed until the period of time measured by the timer 31 has reached the predetermined period of time set in the time setting portion 30.

Also, the control device 3 has a dispensing tip arrangement calculating function 70 (to be described later) and a reagent volume/arrangement calculating function 80 (to be described later). With the dispensing tip arrangement calculating function 70, an arrangement of dispensing tips 8 in the dispensing tip containers 9a and 9b can be determined based on input information regarding the dispensing wells in the microplate 11 and also dispensing direction 36. The arrangement of dispensing tips 8 thus determined is displayed for the operator's convenience.

The memory of the control device 3 stores information regarding the arrangement of the dispensing tips 8 determined by way of the dispensing tip arrangement calculating function 70. The information stored in the memory of the control device 3 is used when the control device 3 determines that the dispensing tip 8 to be mounted on the dispensing head 6 is left in the dispensing tip container 9a or 9b based on the outputs from the dispensing tip sensor 19.

The reagent volume/arrangement calculating function 80 calculates the quantity of reagent 37 to be used and determines the arrangement of reagent 37 in the reagent container 10a or 10b. The quantity of reagent 37 to be used is calculated based on the reagent dispense volume 38 per well of the microplate 11, the number of wells 35 in which the reagent 37 is to be dispensed, and information regarding the dispense direction 36. The calculated quantity of reagent 37 and the arrangement of reagent 37 thus determined are displayed for the operator's convenience and are also stored in the memory of the control device 3. The use of the stored information can eliminate re-calculation for the same conditions, thereby reducing the time necessary for calculation.

Furthermore, the control device 3 has a self-determination function 40. The self-determination function 40 can simulate the time to execute the steps input in advance for a reagent reaction experiment, and determine whether the automatic liquid handling system 1 can execute the operations within the period of time specified at the time setting portion 30, and inform the operator of the result.

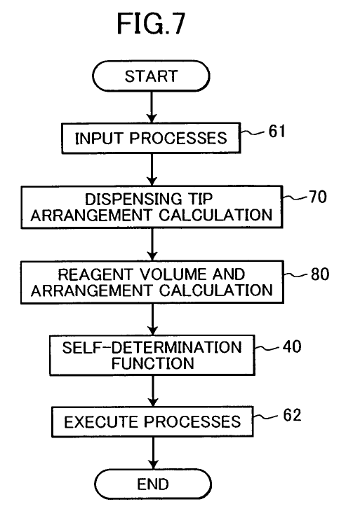

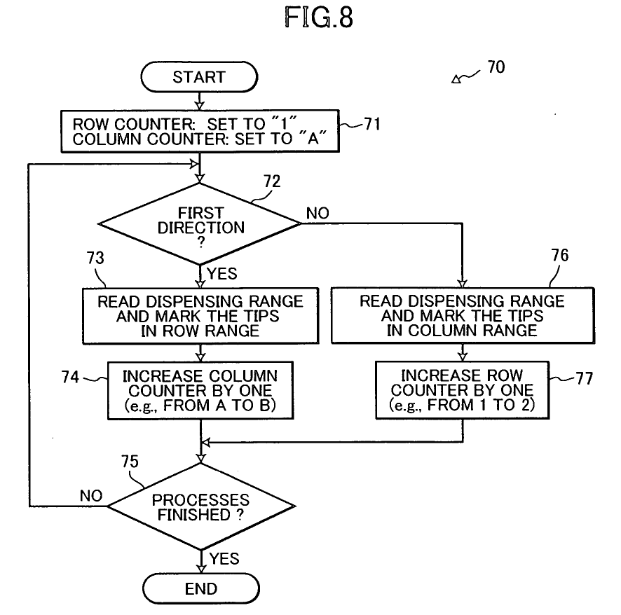

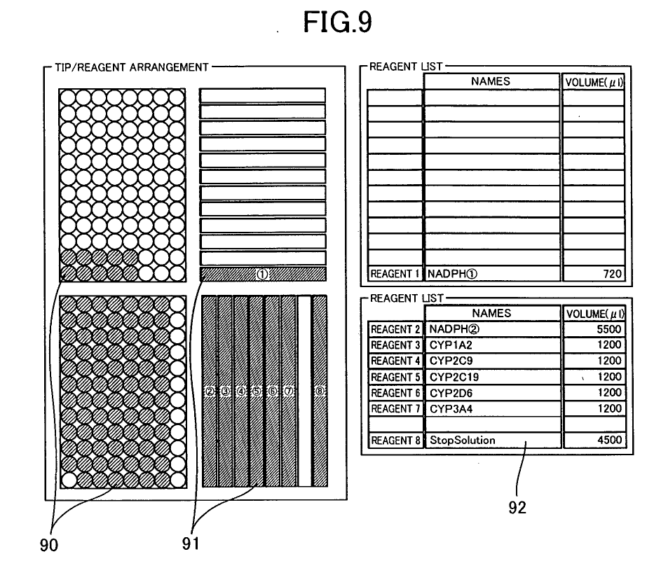

Next, the sequence in time for executing each of the functions of the control device 3 described above will be described referring to the flowchart shown in FIG. 7. At step 61, the operator inputs a series of process steps to be executed. Next, the dispensing tip arrangement calculating function 70 and the reagent volume/arrangement calculating function 80 are executed. Then the self-determination function 40 determines whether the automatic liquid handling system 1 can execute the series of steps within the period of time specified at the time setting portion 30 or not. If the automatic liquid handling system 1 is not capable of executing the steps within the specified period of time, then an alarm is activated, and the operator is instructed to re-enter the series of steps. If the automatic liquid handling system 1 is capable of executing the steps within the specified time, then the dispensing tip and reagent arrangements are displayed together with the reagent quantities, as shown in FIG. 9. The operator sets up each of these items in accordance with the display on the screen. When these preparations are completed, the operator causes the processes to be executed (step 62).

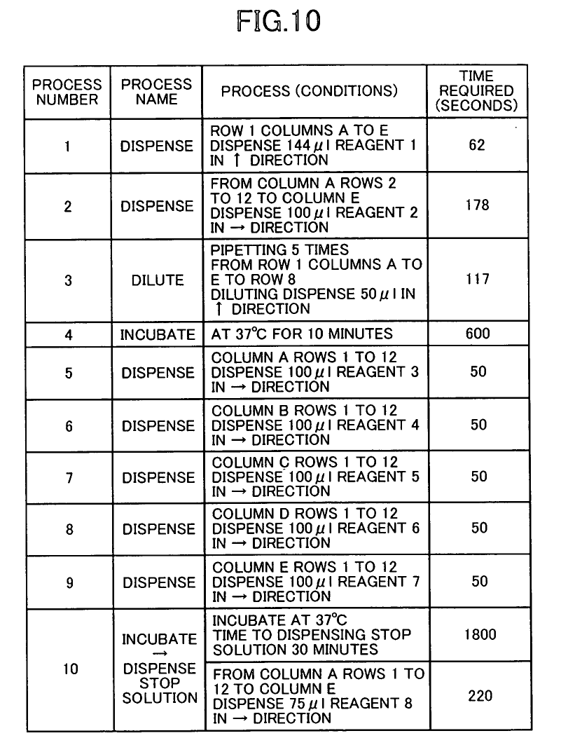

Next, referring to the flowchart in FIG. 8 and the process table shown in FIG. 10, details of the dispensing tip arrangement calculating function 70 will be described. It should be noted that the dispensing tips 8 are to be arranged in the first dispensing tip container 9a on a column-by-column basis. That is, the dispensing tips 8 are firstly arranged in somewhere on column “A” and this column basis dispensing tip arrangement is sequentially performed from column “A” to column “H”. Hereinafter, the direction from column “A” to column “H” (leftward direction in the figure) will be referred to as “first direction” for the purpose of description. On the other hand, the dispensing tips 8 are to be arranged in the second dispensing tip container 9b on a row-by-row basis. That is, the dispensing tips 8 are firstly arranged in somewhere on row “1” and this row basis dispensing tip arrangement is sequentially performed from row “1” to row “12”. Hereinafter, the direction from row “1” to row “12” (upward direction in the figure) will be referred to as “second direction” for the purpose of description.

In the initialization step 71, the row counter is set to “1” and the column counter to “A”. In step 72, decision is made as to whether or not the dispensing tips 8 are to be arranged in the first direction. If affirmative, the dispensing tips 8 will be arranged somewhere on the row “1” in the second dispensing tip container 9b whereas if negative, the dispensing tips 8 will be arranged somewhere on the column “A” in the first dispensing tip container 9a. Referring to the process number 1 shown in the table of FIG. 10, the dispense direction is indicated by an upwardly directed arrow meaning that dispensing operation is performed in the second direction. Therefore, decision made in step 72 is “NO” and the routine proceeds to step 76 where dispensing range on wells of the microplate 11 is read from the process table shown in FIG. 10. The process table indicates that the dispensing range on wells of the microplate 11 is from column “A” to column “E” on row “1”. Accordingly, as shown in FIG. 9, the range from “A” to “E” on row “1” is marked with respect to the dispensing tip arrangement positions of the second dispensing tip container 9b. It should be noted that the dispensing tips 8 set to the above-mentioned positions on the second dispensing tip container 9b are used to dispense the reagent 1 on the wells of the microplate 11 from column “A” to column “E” on row Next, in step 77, the row counter is incremented by 1 to become “12”. Then, in step 75, it is determined whether or not all the process steps are finished. If one or more process steps remain unprocessed, then the procedure returns to step 72 to determine what the next process step is. The dispense direction in process step 2 is indicated by a leftwardly directed arrow in the process table shown in FIG. 10, so the procedure proceeds to step 73. The process to be performed in process step 2 is dispensing the reagent 2 in the microplate wells that are enclosed by a rectangle whose diagonal line is defined by points (A,2) and (E,12). Accordingly, as shown in FIG. 9, the range from “2” to “12” in column “A” is marked with respect to the dispensing tip arrangement positions of the first dispensing tip container 9a. It should be noted that the dispensing tips 8 set to the above-mentioned positions on the first dispensing tip container 9a are used to dispense the reagent 2 on eleven wells on rows “2” to “12” of the microplate 11 of each of columns “A” to “E”.

Next, in process step 74 the column counter is incremented by one to change from “A” to “B”. Then, in process step 75 the procedure checks whether the all process steps are finished, and if further process steps remain unprocessed, the procedure checks for details of process number 3. Then, the procedure as described above is executed, and the dispensing tips 8 used for executing the process in process number 3 are arranged in the second dispensing tip container 9b in positions of row “2” from columns “A” to “E”. In this manner, one column or one row on the well of the microplate 11 is processed at a time until the process in process number 10 is finished. The screen displays the arrangement of dispensing tips 8 as shown in FIG. 9.

The marking of the dispensing tip arrangement 90 can use different colors for the dispensing tips 8 needed in each process. If this type of display is adopted, then the likelihood of a mistake in the arrangement of dispensing tips 8 is further reduced. Also, the method of displaying each process can use symbols, numbers, letters, or the like.

The control device 3 stores in its memory data on the arrangements of the dispensing tips 8 thus obtained. This data is used for determining that one or more dispensing tips 8 are left in the dispensing tip container 9a or 9b after the dispensing tips 8 are mounted on the head 6. The data used for this purpose is not limited to the one obtained through execution of the dispensing tip arrangement computing function 70 but the same data obtained through other measure is also usable. For example, the dispensing tip arrangement data may be created by using the keyboard 17 or the mouse 18 of the control device 3. The data thus created must also be stored in the memory of the control device 3.

Next, the reagent volume/reagent arrangement calculating function 80 for calculating the volume of reagent to be used and the arrangement of reagent will be described. The quantity of reagent to be used is the product of the specified dispense volume per each well and the specified number of wells. For example, in process number 1, the dispense volume is 144 μl (micro litter) and the number of wells is 5, and the product of these is 720 μl. In process number 2, the dispense volume is 100 μl and the number of wells is 11×5, and the product of these is 5500 μl. If the same reagent is used in different processes, then their volumes can be summed.

Next, to determine the reagent layout, a procedure similar to that shown in FIG. 8 is executed. Specifically, the procedure determines whether to set the reagent in the reagent container 10a or 10b depending upon the dispense direction, and the arrangement is determined in order according to the specified reagent. Particularly, in order to avoid contamination of other reagents by the stop solution, the operator can specially arrange the stop solution to be separated from the other reagents.

In this manner, the volume of reagent is calculated and the arrangement of reagents is determined. FIG. 9 shows the resultant arrangement of reagents 1 to 8 as denoted by reference numeral 91, and the calculated volume of each reagent as denoted by reference numeral 92. Referring to the reagent volumes, the operator can dispense slightly more reagent to account for dead volume.

Also, in the display of the arrangement of reagents, the reagent to be used in each process can be shown in separate colors. If this type of display is adopted, then the likelihood of a mistake in the arrangement of reagent is further reduced. Also, the method of displaying each process can use symbols, numbers, letters, or the like. Also, if the same reagent is used several times, then the reagent can be displayed in different positions on the screen.

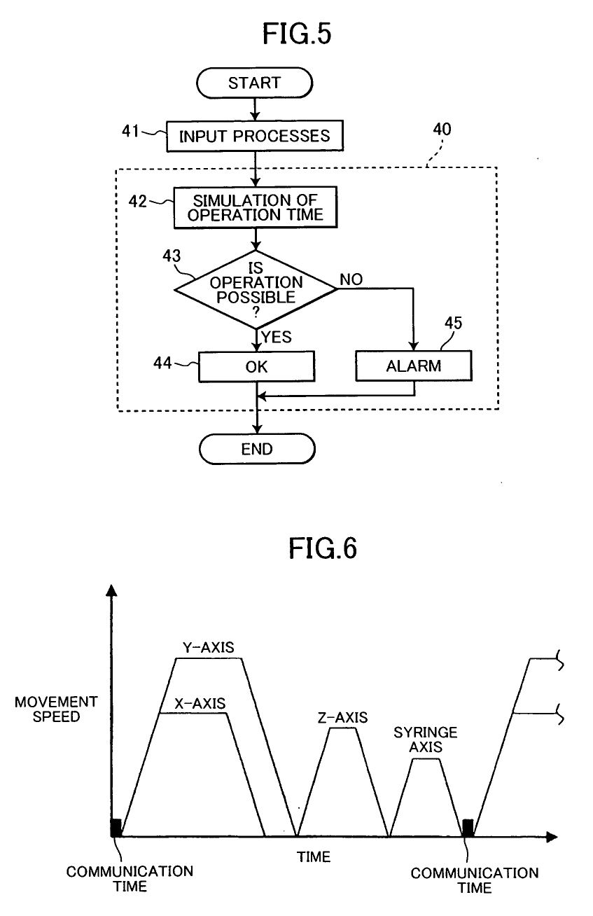

Next, the self-determination function 40 will be described. As described above, an operator prepares a process table listing a series of processes to be executed, such as the process table shown in FIG. 10. The processes are input to the control device 3. The control device 3 has a function for calculating an estimated time needed to execute all the processes listed in the process table based on the processes input to the control device 3. Specifically, the robot 5 is moved at a speed changing in a trapezoidal form as sown in FIG. 6. As such, the movement time and dispense time can be calculated from the gradient of the acceleration or deceleration period, the maximum speed, traveling distance, etc. Naturally, when the robot 5 moves on a plane defined by two axes or moves in a 3D space defined by three axes, it is the axis with the longest movement time that is selected for calculation of the total movement time.

In the example shown in FIG. 6, the robot 5 is firstly moved along the X- and Y-axes simultaneously at the same speed. When the position of the robot 5 on the Y-axis is determined, the robot 5 is moved in the direction of Z-axis. That is, the robot 5 is moved to a predetermined height. Then, the syringe axis is driven in order to suck in or expel reagent into or out of the dispensing tips 8. The times for these movements are calculated. Because each movement is controlled by the control device 3, data transmission time needs to be taken into consideration to obtain the total time required for executing all the operations. It is possible to calculate the data transmission time from the amount of data and the transmission speed. It is therefore possible to simulate the time required for each process by summing the time required to execute each operation in the process and the data transmission time. For example, in the case of process number 1 in FIG. 10, the time required to attach the dispensing tips, suck in the reagent 1 and dispense the reagent in the microplate 11, dispose the dispensing tips 8 in the disposal container 14, and the time required to transmit the commands for each of these operations can be calculated and summed. The result of summing these times is the time required to execute process number 1. In this way, as shown in the “Time Required” column of FIG. 10, the control device 3 can calculate the time required to execute each process.

The self-determination function 40 of the control device 3 determines whether the calculated operation time is in accordance with the required time input at the time setting 30, and informs the operator. Specifically, as shown in the flowchart in FIG. 5, the self-determination function 40 is executed after inputting the processes (step 41). First, the operation time simulation is executed (step 42). Then, the procedure determines whether the processes can be completed within the time input at the time setting 30 (step 43). If it is possible to execute the processes within the time input at the time setting 30, then the message “OK” is output to the screen (step 44). If it is not possible, then “Alarm” is displayed (step 45) to alert the operator that it is not possible to execute the processes within the time input at the time setting 30.

Next, referring to FIGS. 2 and 10, a sensing method of the dispensing tips 8 mounted on the head 6 will be described. In sensing the dispensing tips 8, the dispensing tip sensor 19 is used. To sense the dispensing tips 8 mounted on the head 6, a reference position of the head 6 needs to be set. The reference position is a start position, from which the robot 5 moves to a predetermined direction so that all the dispensing tips 8 mounted on the head 6 can interrupt the light path of the dispensing tip sensor 19. The reference position of the head 6 or the robot 5 is defined by the positions on the X, Y and Z axes. The reference position needs to be such a position where the endmost dispensing tip 8 on the head 6 interrupts the light path of the dispensing tip sensor 19 regardless of whether the head 6 is oriented in the first direction or the second direction.

The positions 6a and 6b of the head 6 as illustrated in FIG. 2 are set to the reference positions. The reference position 6a is set for the head 6 that is oriented in the second direction while the reference position 6b is set for the head 6 that is oriented in the first direction. The reference position 6a is such a position where the endmost dispensing tip corresponding to row “1” interrupts the light path 19c of the dispensing tip sensor 19 and is thus sensed as being mounted on the head 6. Likewise, the reference position 6b is such a position where the endmost dispensing tip corresponding to column “A” interrupts the light path 19c of the dispensing tip sensor 19 and is thus sensed as being mounted on the head 6.

The reference positions 6a, 6b of the head 6 are not limited to the positions illustrated in FIG. 2. In the two reference positions 6a and 6b in FIG. 2, the positions where the endmost dispensing tips interrupt the light path 19c are the same. However, the light path interrupting position on the light path 19c may not necessarily be the same in both cases where the head 6 is oriented in the first direction and the second direction.

With the geometrical relation between the head 6 and the light path 19c of the dispensing tip sensor 19 as described, the control device 3 determines that the dispensing tip 8 is mounted on the head 6 when the light path 19c of the sensor 19 is interrupted whereas the control device 3 determines that the dispensing tip 8 is not mounted on the head 6 when the light path 19c is not interrupted. The dispensing tips 8 are mounted on the head 6 at an interval of 9 mm. Therefore, by moving the robot 5 by 9 mm in the direction in which the dispensing tips 8 are aligned on the head 6 from the reference position 6a or 6b, the second dispensing tip 8 adjacent to the endmost one can be detected. The movement of the robot 5 is performed every 9 mm from the reference position until all the dispensing tips 8 mounted on the head 6 can be detected. The head 6 can mount twelve dispensing tips at maximum and each of which can be sensed while identifying its position.

Sensing the dispensing tips 8 is performed in two occasions. One is to sense the dispensing tips 8 after mounting the same on the head 6 is completed. The other is to sense the dispensing tips 8 which may be left on the head 6 after the dispensing tips 8 are removed from the head 6. Each of these two sensing operations is performed in two ways depending on which direction the head 6 is oriented.

To sense the dispensing tips 8 after mounting the same on the head 6, the dispensing tip arrangement data as stored in the memory of the control device 3 is utilized. When a reagent reaction experiment is conducted, the dispensing tips 8 are not arranged on all the tip receiving portions of the dispensing tip container 9a or 9b but arranged on selected tip receiving portions in accordance with the conditions in each process of the experiment. The arrangement of the dispensing tips 8 is accomplished by executing the dispensing tip arrangement calculating function 70 as described previously. The data created by the dispensing tip arrangement calculating function 70 is stored in the memory of the control device 3. After the dispensing tips 8 arranged on the dispensing tip container 9a or 9b are mounted on the head 6, comparison is made between data obtained from the dispensing tip sensor 19 and the data stored in the memory of the control device 3 to determine that the dispensing tips 8 are mounted in relevant positions on the head 6.

For example, in the process 1 shown in the process table of FIG. 10, upon swiveling the head 6 to be oriented in the first direction with a swiveling mechanism (not shown), the head 6 mounts thereon five dispensing tips 9 set in columns “A” to “E” on row “1” of the dispensing tip container 9b. Although the head 6 is capable of mounting twelve dispensing tips 8 at maximum, five dispensing tips 8 are mounted on the head 6 in positions from the third to seventh locations counted from the leftmost location of the head 6 shown in FIG. 2. It should be noted that the third to seventh locations are the right locations to mount the dispensing tips 8. After mounting the dispensing tips 8 on the head 6 is complete, the head 6 is moved by the robot 5 to the reference position 6b.

In the reference position 6b, determination is made as to whether the dispensing tip 8 is mounted on the leftmost location of the head 6 or not. When it is determined that the dispensing tip 8 is mounted in this location, the control device 3 displays an alarm to draw the operator's attention to this improper condition and stops the operation. On the other hand, when it is determined that the dispensing tip 8 is not mounted in the leftmost location of the head 6, then the robot 5 moves the head 6 by 9 mm in the first direction or leftward direction in FIG. 2 in order to determine that the dispensing tip 8 is not present in the second location counted from the leftmost location of the head 6. Should the dispensing tip 8 be sensed in the second location, the control device 3 displays an alarm to draw the operator's attention to this improper condition and stops the operation. If determination is correctly made so that the dispensing tip 8 is not present in the second location, then the robot 5 further moves the head 6 in the first or leftward direction by 9 mm in order to determine that the dispensing tip 8 is present in the third location. Should the dispensing tip 8 be not sensed in the third location, the control device 3 displays an alarm to draw the operator's attention to this improper condition and stops the operation. If determination is correctly made so that the dispensing tip 8 is present in the third location, then the robot 5 further moves the head 6 in the first or leftward direction by 9 mm in order to determine that the dispensing tip 8 is present in the fourth location.

In a manner as described above, check results are obtained such that the dispensing tips 8 are present in the third to seventh locations of the head 6 and not in the remaining locations of the head 6. If the intended check results are not obtained, then control device 3 displays an alarm to draw the operator's attention and stops the operation. When the intended check results are obtained, the head 6 is moved to a position above the reagent container 10a or 10b to suck the reagent 1 into the dispensing tips 8 mounted on the head 6. While the above description is directed to the case where the dispensing head 6 is oriented in the first direction, the dispensing tips 8 mounted on the head 6 that is oriented in the second direction can similarly be sensed by moving the head 6 in the second or downward direction in the diagram of FIG. 2.

To sense the dispensing tips 8 which may remain on the head 6 after removing the dispensing tips 8 from the head 6, the robot 5 moves the head 6 to the reference position 6a or 6b depending on the direction in which the head 6 is oriented when the dispensing tip removing operation is performed. The used dispensing tips 8 are removed from the head 6 with a tip removing mechanism (not shown) at a position above the disposal container 14. After removal of the dispensing tips 8, the control device 3 checks if all the dispensing tips 8 are removed from the head 6.

It is now assumed that the dispensing tips 8 are removed in a condition where the head 6 is oriented in the second direction. After the dispensing tip removing operation is complete, the robot 5 moves the head 6 to the reference position 6a. In the reference position 6a, determination is made as to whether the dispensing tip 8 is mounted on the lowermost location of the head 6 or not in the diagram of FIG. 2. When it is determined that the dispensing tip 8 is mounted in this location, the control device 3 displays an alarm to draw the operator's attention to this improper condition and stops the operation. On the other hand, when it is determined that the dispensing tip 8 is not mounted in the lowermost location of the head 6, then the robot 5 moves the head 6 by 9 mm in the second direction or downward direction in FIG. 2 in order to determine that the dispensing tip 8 is not present in the second location counted from the lowermost location of the head 6.

Similar to the operation as described above, check results are obtained such that the dispensing tips 8 are not present in the remaining locations of the head 6. If the intended check results are not obtained, then control device 3 displays an alarm to draw the operator's attention and stops the operation. When the intended check results are obtained, the control device 3 executes the next job.

While the above description is directed to the case where the dispensing head 6 is oriented in the second direction, the dispensing tips 8 mounted on the head 6 that is oriented in the first direction can similarly be sensed by moving the head 6 in the first or leftward direction in the diagram of FIG. 2.

In the above description, the control device 3 displays an alarm and stops the operation when the intended check results are not obtained. However, the operation may not be stopped but be continued to the end of the process number even if an alarm is displayed during operation. In this case, the control sequence may be set in advance so that the abnormally processed process number and the contents of abnormality are displayed after all the processes are complete.

An additional dispensing tip container with the dispensing tips 8 disposed therein may be provided to supplement the dispensing tips 8. The dispensing tips 8 in the additional dispensing tip container are mounted to some of the locations of the head 6 on which the dispensing tips 8 are erroneously not mounted. When an excessive number of dispensing tips 8 are mounted on the head 6, unwanted dispensing tips 8 are removed from the head 6 one by one with the use of a tip remover.

In the above-described embodiment, the head 6 is moved every 9 mm interval in sensing the dispensing tips 8 mounted on the head 6. However, it is not necessary to move the head 6 on this basis if the dispensing tips 8 collide with the reagent container 10a or 10b or the microplate 11. The robot 5 may be driven to move the head 6 so that the individual dispensing tip 8 interrupts the light path 19c of the sensor 19.

Further, in the above-described embodiment, the head 6 is moved intermittently to sense presence or absence of each of the dispensing tips 8. However, to achieve the same goal, the head 6 may be moved continuously at a constant speed over a distance covering all the dispensing tips mounting locations on the head 6. If this is done, the dispensing tip sensor 19 outputs a pulse train indicative of the presence or absence of the dispensing tips 8 in relation to the locations on the head 6 as the head 6 traverses across the light path 19c. The pulse trail output from the dispensing tip sensor 19 is stored in the memory of the control device 3 and compared with a predetermined pulse train indicative of the intended dispensing tip arrangement, thereby providing information about mounting or dismounting error of the dispensing tips.

The following is an explanation of the actual operation, using the processes shown in FIG. 10 as an example. Firstly, the operator adds by hand 6 μl of the test specimen to wells A to E of row 1 of the microplate 11 in advance. The microplate 11 is placed on the shaker 13, and the door is closed. Then, the operator starts the processes input to the control device 3.

In process number 1, the head 6 mounts the five dispensing tips 8 set in the dispensing tip container 9b in columns “A” to “E” of row “1”. Thereafter, it is checked to see if the five dispensing tips 8 are duly mounted on the predetermined locations on the head 6. Next, 144 μl of reagent 1 in the reagent container 10b is sucked in, and dispensed in wells in columns “A” to “E” of row “1” of the microplate 11 placed on the shaker 13. The amplitude of shaking of the shaker 13 is about +/−1 mm, which is sufficiently small compared with the diameter of the wells, 8 mm. Therefore, even during incubation operations, dispensing operations can be carried out. After dispensing operations are completed, the dispensing tips 8 are disposed of in the disposal container 14 in order to avoid contamination. Thereafter, it is checked to see if there remain one or more dispensing tips 8 in the head 6 after the disposal operation.

In process number 2, the head 6 mounts the eleven dispensing tips 8 set in column “A”, rows “2” to “12” of dispensing tip container 9a. Then, it is checked to see if the eleven dispensing tips 8 are duly mounted on the predetermined locations on the head 6. Before this operation, the dispensing head 6 is rotated through 90 degrees. Then, 100 μl of reagent 2 stored in portion “A” of reagent container 10a is sucked in, and dispensed in wells “2” to “12” of column “A” of the microplate 11 placed on top of the shaker 13. Then, 100 μl of reagent 2 in portion “A” of reagent container 10a is again sucked in, and dispensed to wells “2” to “12” of column “B”. This operation is repeated until the operation in column “E” is executed, and the dispensing tips 8 are disposed of into the disposal container 14. Thereafter, it is checked to see if no dispensing tips 8 remain in the head 6.

The rotation of the dispensing head can be accomplished using, for example, a stepper motor or a solenoid or other type of actuator. Alternatively, a disk can be provided on the dispensing head, and an abutment member provided on the main body 2 of the automatic liquid handling system 1, so that the abutment member is capable of contacting the disk on the dispensing head 6. While the disk is contacting the abutment member, the dispensing head 6 is moved in the X or the Y-axis, causing the dispensing head 6 to rotate. The axis of rotation of the dispensing head 6 corresponds to the center of the dispensing head 6.

For the dilution operation in process number 3, firstly the dispensing head 6 is rotated and the dispensing tips 8 set in row “12”, columns “A” to “E” of dispensing tip container 9b are mounted on the dispensing head 6. Then, it is checked to see if the five dispensing tips 8 are duly mounted on the predetermined locations on the head 6. The dispensing head 6 moves to row “1” of the microplate 11 on top of the shaker 13, and dips the dispensing tips 8 into the liquid in wells “A” to “E” of row “1”. An agitation operation consisting of sucking in and expelling out the liquid is repeated five times. Then, 50 μl of liquid is sucked in, and 50 μl is dispensed into the neighboring wells “A” to “E” of row “2”. This liquid is sucked in and expelled out five times. In the same way, 50 μl from row “2” is dispensed into row “3”, then agitated and diluted. This type of operation is repeated until row “8”. The dispensing tips 8 are disposed of in the disposal container 14 together with the 50 μl of liquid sucked in from row “8”. Then, it is checked to see if none of the dispensing tips 8 remain on the head 6. In the process described above, diluted test specimen is generated in row “1” to “8” of the microplate 11.

In process number 4, an incubation operation is carried out by shaking the microplate 11 for 10 minutes at a fixed temperature, for example 37° C. The control device 3 executes the following process after the 10 minutes incubation time is complete.

Process numbers 5 to 9 are processes for dispensing reagent into the wells of columns “A” to “E” of microplate 11. The following is an explanation of how timers A to E provided for each column of microplate 11 measure the time from dispensing reagent.

In process number 5, the dispensing head 6 rotates through 90 degrees to be oriented in the second direction, and mounts the dispensing tips 8 set in rows “1” to “12” of column B of the dispensing tip container 9a to the dispensing head 6. The, it is checked to see if the twelve dispensing tips 8 are duly mounted on the predetermined locations on the head 6. Next, 100 μl of reagent 3 contained in portion B of reagent container 10a is sucked in, and dispensed to wells “1” to “12” of column “A” of the microplate 11 on top of the shaker 13. Immediately after this, the control device 3 causes the timer A to clear to 0 and start counting up. Timer A counts up in units of one millisecond, for example. After dispensing, the twelve dispensing tips 8 are disposed of in the disposal container 14, whereupon it is checked if none of the dispensing tips 8 remain in the head 6.

In process number 6, similar to process number 5, 100 μl of reagent 4 contained in portion “C” of reagent container 10a is sucked in, and dispensed to wells “1” to “12” of column B of the microplate 11. Immediately after this, the control device 3 causes the timer B to clear to 0 and start counting up.

Thereafter, similar processes are executed until process number 9, with reagents 5 to 7 being dispensed to columns “C” to “E” of the microplate 11, and timer C, timer D, and timer E started.

The time required for each dispensing operation is 50 seconds. Therefore, timer B is 50 seconds later than timer A, and timer C is 50 seconds later than timer B, and similarly for timers D and E.

In process number 10, the microplate 11 in which reagent has been dispensed is incubated for 30 minutes at 37° C., following which 75 μl of stop solution is dispensed into columns “A” to “E” of the microplate 11. Firstly, dispensing tips 8 from column “G” of dispensing tip container 9a are mounted on the dispensing head 6. Thereafter, it is checked to see if the twelve dispensing tips 8 are duly mounted on the predetermined locations on the head 6. Then, 75 μl of reagent, which is reaction stop solution, in the portion “H” of reagent container 10a is sucked in. The incubation operation is executed while comparing the desired reaction time input at the time setting 30, in other words 30 minutes or 1,800 seconds, with the time on the timer A. When the time on timer A reaches the 1,800 seconds, reagent 8 is dispensed into column “A” of the microplate 11. After dispensing, reagent is again sucked in, and the dispensing head 6 waits at column B of the microplate 11. When timer B reaches 1,800 seconds, reagent B is dispensed into column B. Thereafter, similar operations are executed until reagent is dispensed into column “E” and reagent reactions are stopped in each of columns “A” to “E”. The control device 3 measures the time on timers A to E, in other words, the time from immediately after reagent is dispensed until the time when stop solution is dispensed. This time can be displayed on the screen, or recorded to a memory medium or printer not shown on the drawings. The position where the dispensing head 6 waits for the reaction time to be complete is not necessarily above the wells, but a suitable position would be where even if drops of the stop solution sucked into the dispensing tips 8 fell from the dispensing tips 8, they would cause no obstruction to the experiment. Also, stop solution for which temperature control is critical, and whose temperature would change to the ambient temperature if left standing in the dispensing tips 8, can be sucked from column “H” of the reagent container 10a just before the end of the reaction time.

The subsequent operations consist of the operator removing the microplate 11, and measuring the fluorescence intensity of the reaction products using a fluorescent plate reader (not shown).

The time setting 30 described above is provided in the “Incubate→Dispense stop solution” information input screen 34. However, information input screen 34 for processes dispensing reagent for which time control is important can also be provided. A timer 31 is provided for measuring the time from dispensing the reaction start reagent for every column of the microplate 11, so it can be easily understood that an operation similar to the one described above can be performed.

In the processes taken as an example and described above, the time until dispensing the stop solution was 30 minutes. However, if this time were, for example, three minutes, then the time would finish during the time between executing process number 5 and process number 9. In this case, the self-determining function 40 described above would simulate the actual process time for the processes created, and confirm whether the operations were possible or not. In other words, the self-determination function would determine whether, for example, during the time from start of process number 5 to the time of dispensing the stop solution, there was sufficient time to execute another process.

Also, in the process examples described above, the reaction time for the different reagents was set to the same duration. However, it is also possible to carry out experiments where the same reagent is added to the test specimen, and different times are provided for each column. In this case, after dispensing to the range of wells for the reagent, the time set at “Incubate→Dispense Stop solution” will be different for each column. In this kind of experiment, even if a fault should occur in the equipment during execution of a process or for some reason it becomes necessary to stop the equipment, then because the timer 31 will have measured the actual time from immediately after dispensing the reagent until the stop solution was dispensed, use can be made of the test results for the experiment.

In the embodiment of the present invention described above, an example was given where dispensing tips 8 were disposed of. However, fixed tips that are cleaned can also be used. Also, a microplate 11 with 96 wells was used as an example in the description. However, the present invention can also be easily applied to a dispensing head 6 for microplates 11 for smaller quantities with 384 wells or 1,536 wells.

What is claimed is:

1. An automatic liquid handling system comprising:
a dispensing tip container having a plurality of holding portions for holding dispensing tips;
a dispensing head having attachment portions to which at least one dispensing tip is attached, wherein when one or more dispensing tips are attached to the attachment portions, the dispensing head is capable of performing sucking and expelling operations for sucking liquid in or expelling the liquid out from the one or more dispensing tips;
a moving mechanism that moves the dispensing head;
a sensor that senses if one or more dispensing tips are attached to the attachment portions of the dispensing head when the head moves relative to the sensor, wherein the sensor has a sensing region that extends in a direction slanted with respect to a direction in which the dispensing head moves, and generates an output indicative of a status of the dispensing tips attached to the attachment portions of the dispensing head; and
a control device that controls the sucking and expelling operations performed by the dispensing head and controls the moving mechanism to control movements of the dispensing head.

2. The automatic liquid handling system according to claim 1, wherein the sensor optically senses one or more dispensing tips.

3. The automatic liquid handling system according to claim 2, wherein the sensor comprises a light emitting unit and a light receiving unit disposed apart a predetermined distance from the light emitting unit, a light path being formed between the light emitting unit and the light receiving unit, wherein the moving mechanism moves the dispensing head to traverse the light path.

4. The automatic liquid handling system according to claim 1, further comprising a memory that stores information about a number of dispensing tips to be attached to the attachment portions of the dispensing head with position data indicating the holding portions to which the dispensing tips are to be attached, wherein the control device compares the output of the sensor with the information stored in the memory.

5. The automatic liquid handling system according to claim 4, further comprising adjusting means for adjusting the number of dispensing tips attached to the attachment portions of the dispensing head and the attachment positions of the dispensing tips as indicated by the information stored in the memory when the control device generates a comparison result indicating that the output of the sensor and the information stored in the memory are not in coincidence with each other.

6. The automatic liquid handling system according to claim 4, wherein when the control device generates a comparison result indicating that the output of the sensor and the information stored in the memory are not in coincidence with each other, the control device controls the moving mechanism to stop movement of the dispensing head.

7. The automatic liquid handing system according to claim 6, wherein the control device generates the comparison result each time comparison is performed with respect to one attachment portion of the dispensing head.

8. The automatic liquid handing system according to claim 6, wherein the control device generates the comparison result after comparison is performed with respect to all the attachment portions of the dispensing head.

9. The automatic liquid handling system according to claim 3, wherein the moving mechanism moves the dispensing head in a three dimensional space defined by X-axis, Y-axis, and Z-axis, and swivels the dispensing head in a plane defined by the X-axis and the Y-axis, wherein the light emitting unit and the light receiving unit are disposed in the plane defined by the X-axis and the Y-axis in such a positional relationship that the light path forms 45 degrees with respect to the X-axis and the Y-axis, and the moving mechanism moves the dispensing head in a direction of the X-axis or the Y-axis to traverse the light path.
